(19) United States
(12) Patent Application Publication
(10) Pub. No.: US 2026/0027869 A1
(43) Pub. Date: Jan. 29, 2026

(54) INFORMATION PROCESSING METHOD

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/219,257

(22) Filed: May 27, 2025

(30) Foreign Application Priority Data
Jul. 25, 2024 (JP) 2024-120414

(51) Int. Cl. B60H 1/00; G06T 7/70; G06V 20/56; G06V 20/59; G06V 40/10

(52) U.S. Cl. CPC B60H 1/00742; G06T 7/70; G06V 20/56; G06V 20/597; G06V 40/10; G06T 2207/30196; G06T 2207/30252; G06T 2207/30268

(57) ABSTRACT

An information processing apparatus receives from a terminal apparatus of a user a designation of one or more seating conditions desired by the user. The information processing apparatus then identifies, upon detecting a person from a video of an area around or inside a bus captured by a camera, a position of the detected person. The information processing apparatus then determines whether the identified position of the person and a current position of the terminal apparatus match. Then, in a case in which they match, the information processing apparatus determines a seat for the user based on the one or more seating conditions.

### CROSS-REFERENCE TO RELATED APPLICATION

This application claims priority to Japanese Patent Application No. 2024-120414, filed on Jul. 25, 2024, the entire contents of which are incorporated herein by reference.

### TECHNICAL FIELD

The present disclosure relates to an information processing method.

### BACKGROUND

Technology used for personalizing vehicle seating is known. For example, Patent Literature (PTL) 1 discloses an invention that determines the boarding position of a passenger and when it is a predetermined position, changes the air conditioning setting.

### CITATION LIST

### Patent Literature

PTL 1: JP 2018-002017 A

### SUMMARY

There is room for improvement with respect to technology used for personalizing vehicle seating.

It would be helpful to improve technology used for personalizing vehicle seating.

An information processing method according to an embodiment of the present disclosure is an information processing method performed by an information processing apparatus configured to control operations of a bus, the information processing method including:
receiving from a terminal apparatus of a user a designation of one or more seating conditions desired by the user;
identifying, upon detecting a person from a video of an area around or inside the bus captured by a camera, a position of the detected person;
confirming whether the identified position of the person and a current position of the terminal apparatus match; and
determining, in a case in which they match, a seat for the user based on the one or more seating conditions.

According to an embodiment of the present disclosure, technology used for personalizing vehicle seating is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of an information processing apparatus.

### DETAILED DESCRIPTION

Hereinafter, an embodiment of the present disclosure will be described.

### Outline of Embodiment

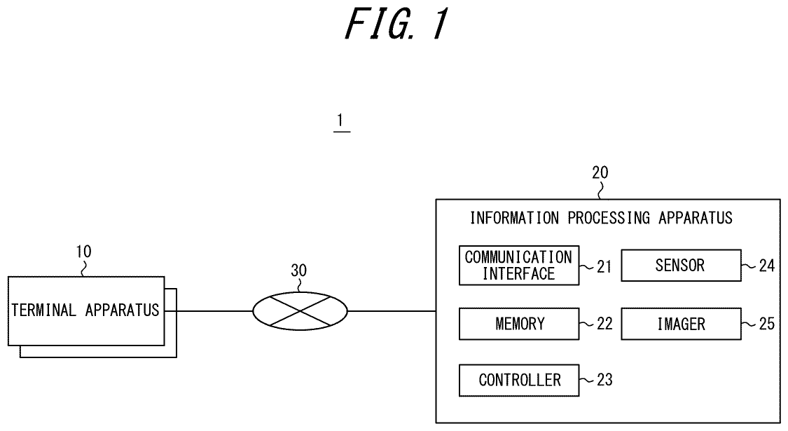

An outline of a system 1 according to the embodiment of the present disclosure will be described with reference to FIG. 1. The system 1 includes a plurality of terminal apparatuses 10 and an information processing apparatus 20. The plurality of terminal apparatuses 10 and the information processing apparatus 20 are communicably connected to a network 30 including, for example, the Internet, a mobile communication network, or the like.

The terminal apparatuses 10 are computers, such as personal computers (PCs), smartphones, or tablet terminals, for example. In the present embodiment, the terminal apparatuses 10 are used by, for example, users who use a bus, and are carried by the users.

The information processing apparatus 20 is, for example, an in-vehicle apparatus mounted in a bus. The information processing apparatus 20 can communicate with the plurality of terminal apparatuses 10 via the network 30.

First, an outline of the present embodiment will be described, and details thereof will be described later. The information processing apparatus 20 receives a designation of one or more seating conditions desired by a user from a terminal apparatus 10 of the user. Next, upon detecting a person from a video of an area around or inside a bus captured by a camera, the information processing apparatus 20 identifies the position of the detected person. The information processing apparatus 20 then determines whether the identified position of the person and the current position of the terminal apparatus 10 match. If they match, the information processing apparatus 20 determines a seat for the user based on the one or more seating conditions.

Conventional technology used for personalizing vehicle seating is oriented toward personally owned vehicles (POVs) and not toward vehicles such as buses, for example, which have a large interior and cannot be personalized on a seat-by-seat basis for an unspecified number of people. In contrast, according to the present embodiment, when a user boards a bus, the seat for the user is determined based on one or more seating conditions desired by the user. Therefore, for example, if a user desires a seat with stronger air conditioning settings, the bus can decide in advance which seat has stronger air conditioning settings, thereby providing a seat that meets the user's preference and personalizing the vehicle seating. Therefore, the present embodiment improves the technology used for personalizing vehicle seating in that it allows personalization of the vehicle seating in a bus.

Next, configurations of the system 1 will be described in detail.

### (Configuration of Terminal Apparatus)

As illustrated in FIG. 1, the terminal apparatus 10 communicates with the information processing apparatus 20 via the network 30. The terminal apparatus 10 includes, for example, a display for outputting information as video, a speaker for outputting information as audio, or the like. The terminal apparatus 10 also includes at least one input device for detecting an input operation by the user, such as a physical key, a capacitive key, a mouse, a touch panel, a touch screen integrally provided with a display, a microphone, or the like.

### (Configuration of Information Processing Apparatus)

As illustrated in FIG. 1, the information processing apparatus 20 includes a communication interface 21, a memory 22, a controller 23, a sensor 24, and an imager 25. In the present embodiment, the information processing apparatus 20 may be configured by the in-vehicle device of the bus and the server, etc., which are connected to the communicably via the network 30 with the in-vehicle device of the bus and the plurality of terminal apparatuses 10.

The communication interface 21 includes at least one communication interface for connecting to the network 30. The interface for communication is compliant with, for example, but not limited to, a mobile communication standard, a wired local area network (LAN) standard, or a wireless LAN standard, and may be compliant with any appropriate communication standard. In the present embodiment, the information processing apparatus 20 communicates with each terminal apparatus 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, embedded software, and the like. In the present embodiment, the memory 22 stores one or more seating conditions desired by each user received from each terminal apparatus 10 in association with information that can uniquely identify each terminal apparatus 10, such as a terminal ID.

The controller 23 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 23 controls operations of the entire information processing apparatus 20.

The sensor 24 includes at least one device for acquiring positional information for the terminal apparatus 10. Specifically, the sensor 24 is, for example, one or more beacons installed on the bus, but is not limited to these and may be any sensor such as the Global Positioning System (GPS). The sensor 24 may be located near where the bus stops, for example, an area around a bus stop.

The imager 25 includes one or more cameras installed on the bus that can capture an area around or inside the bus. The imager 25 may be installed, for example, at the entrance to the bus. Alternatively, the imager 25 may be located near where the bus stops, such as an area around a bus stop, for example. Cameras installed on the bus may also include thermographic cameras.

### (Flow of Operations of Information Processing Apparatus)

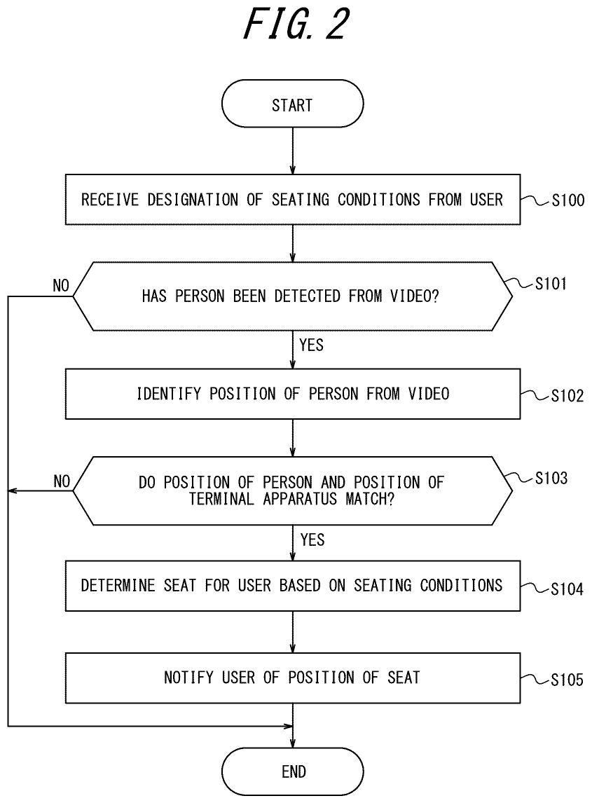

Operations of the information processing apparatus 20 according to the present embodiment will be described with reference to FIG. 2.

S100: The controller 23 of the information processing apparatus 20 receives from the terminal apparatus 10 of the user a designation of one or more seating conditions desired by the user.

Details will be described. For example, before boarding a bus, the user uses the form displayed on the screen of the terminal apparatus 10 of the user to enter a designation of one or more desired seating conditions presses the decision button. When the decision button is pressed, the terminal apparatus 10 transmits the designation of one or more seating conditions to the information processing apparatus 20. The controller 23 receives the designation of one or more seating conditions via the network 30 and stores them in the memory 22 associated with the terminal ID of the terminal apparatus 10. The input of the designation of one or more desired seating conditions by the user is not limited to the above, but any method can be employed.

The “one or more seating conditions” include, for example, an air conditioning setting, but are not limited to this and may include any seating condition, such as the bus stop where the user gets on or off, whether a priority seat is used, a seating position such as window or aisle, lighting, sunlight, smoking preference, etc. The one or more seating conditions may also include any information used in determining the seat or notifying the user of the seating position, such as the user's height, weight and age, presence or absence of visual impairment, presence or absence of hearing loss, presence or absence of a request for assistance in getting on and off the vehicle, presence or absence of vibration notification, etc. Each of the seating conditions included in one or more seating conditions may be assigned a priority.

The condition regarding “air conditioning setting” may be expressed, for example, by “strong,” “medium,” “weak,” or any other form capable of indicating the degree of intensity of air conditioning, such as 3, 2, 1, or by a numerical value, such as 20° C., 20° C. to 23° C. The conditions regarding the air conditioning settings may also include information regarding the humidity desired by the user.

S101: The controller 23 detects a person from a video of an area around or inside the bus captured by the camera.

For example, an object detection model such as YOLO may be used to detect a person from said video captured by a camera, but any method for detecting a person can be employed, including but not limited to this.

S102: If a person has been detected in S101, the controller 23 identifies the position of the person from the video.

As in S101, an object detection model such as, but not limited to, YOLO may be used to identify the position of a person from the video, but any method can be employed.

S103: The controller 23 determines whether the position of the person identified in S102 and the current position of the terminal apparatus 10 match.

Specifically, when the controller 23 identifies the position of the person in question in S102, the controller 23 uses the sensor 24, e.g., one or more beacons, to identify the position of the terminal apparatus 10. If the position of the terminal apparatus 10 is identified, the controller 23 compares the position of the person in question with the position of the terminal apparatus 10, and if they match, proceeds to S104.

The position of the person identified in S102 and the position of the terminal apparatus 10 identified in S103 may be expressed using coordinates, but may be expressed in any format that specifically indicates the position of the person and the terminal apparatus 10 and allows comparison.

The controller 23 may receive the position of the terminal apparatus 10 from the terminal apparatus 10. Specifically, when the controller 23 identifies the position of a person in S102, the controller 23 requests the transmission of the positional information for the terminal apparatus 10 to the terminal apparatus 10. Upon receiving the request, the terminal apparatus 10 acquires its own position using GPS, for example, and transmits the position to the information processing apparatus 20.

S104: The controller 23 determines the seat for the user based on one or more seating conditions.

Specifically, the controller 23 acquires the terminal ID of the terminal apparatus 10 when identifying the position of the terminal apparatus 10 in S103. Next, the controller 23 acquires one or more seating conditions associated with the terminal ID from the memory 22. Then, for example, suppose that the first condition regarding air conditioning settings is included in the one or more acquired seating conditions, and that the first condition specifies 18° C. to 23° C. Suppose also that the bus on which the user boards has the air conditioning setting set at 20° C. for the seats in the back and 25° C. for the other seats. In this case, the controller 23 determines the seat in the back as the seat for the user. For example, if the one or more acquired seating conditions further include a second condition regarding the seating position, and the second condition is window side, the controller 23 determines the back seat on the window side as the seat for the user. In this way, the controller 23 determines the seat as the seat for the user to satisfy all of the one or more seating conditions. If all of the one or more seating conditions cannot be met, the controller 23 may refer to the priority of each of the one or more seating conditions and determine the seat for the user, giving priority to the condition with the highest priority.

The controller 23 may determine the seat for the user based further on bus operation information. Specifically, if one or more seating conditions include a condition regarding sunlight, and the condition was to avoid sunlight, the controller 23 may use information regarding sunlight on the bus route included in the bus operation information to determine the seat on the side not exposed to sunlight as the seat for the user.

S105: The controller 23 notifies the user of the seat for the user determined in S104.

Specifically, the controller 23 transmits information on the seat for the user to the terminal apparatus 10. The terminal apparatus 10 displays the information on the seat for the user received from the information processing apparatus 20 on the display of the terminal apparatus 10. Notification to users may be made, for example, by displaying signage or issuing seat lamps inside the bus. For example, if one or more seating conditions include a condition regarding the presence or absence of a visual impairment, and the condition is that there is a visual impairment, the controller 23 may notify the user by means of an announcement in the bus. For example, if one or more seating conditions include a condition regarding the presence or absence of vibration notification, and the condition is that vibration notification is present, the controller 23 may notify the user by vibrating the terminal apparatus 10 more strongly the closer the user is to the determined seat.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the terminal apparatus 10 can also be implemented. For example, the terminal apparatus 10 may be equipped with some or all of the components of the information processing apparatus 20. For example, the information processing apparatus 20 according to the above embodiment may be used to provide Mobility as a Service (MaaS), a service that leverages mobility.

For example, in the embodiment described above, the controller 23 may change the air conditioning settings according to the number of passengers on the bus. In this case, if the one or more seating conditions include the first condition regarding the air conditioning settings, the controller 23 may determine the seat for the user based on the changed air conditioning settings and the one or more seating conditions.

Specifically, the controller 23 acquires the number of passengers on the bus using the sensor 24 and/or the imager 25 installed in the bus. At this time, for example, there is no person seated only in the back seat, the air conditioning setting of the bus is total air conditioning, and the user has specified 18° C. to 23° C. as the first condition. In this case, the controller 23 may set only the back seat to an individual 20° C. air conditioning setting and determine the back seat as the seat for the user.

For example, in the embodiment described above, the controller 23 may detect that the user is seated in the determined seat and acquire a thermographic image of the user after the user is seated. The controller 23 may then change the air conditioning settings around the user based on the thermographic image.

Specifically, the controller 23 detects that the user is seated in the determined seat by monitoring the movement of the user whose seat was determined in S104 using the sensor 24 and/or the imager 25 installed in the bus. Upon detecting that the user is seated in the seat, the controller 23 acquires a thermographic image of the user at regular intervals or in real time using the imager 25. Then, for example, if the thermographic image indicates that the user is too cold, the controller 23 may raise the temperature of the air conditioning around the user by several degrees. The fact that the user was determined to be too cold and the temperature of the air conditioning was increased may be stored in the memory 22 as past boarding information for the user.

The “past boarding information for the user” may include, for example, any information about the user's past bus boarding, including but not limited to the aforementioned change in the air conditioning settings around the user and the user being seated in a seat different from the one notified to the user.

For example, in the embodiment described above, the controller 23 may determine the seat for the user based on the past boarding information for the user and one or more seating conditions.

Specifically, for example, suppose that the past boarding information for the user includes the fact that the user is seated in the front seat despite the previous notification of a seat in the back, that one or more seating conditions include the first condition regarding air conditioning settings, and that the first condition specifies 18° C. to 23° C. In this case, the controller 23 may determine the seat in front, where the air conditioning is set at 20° C., as the seat for the user. If the past boarding information for the user and one or more seating conditions do not match, the controller 23 may give priority to one or the other to determine the seat. Specifically, for example, suppose that the past boarding information for the user includes the fact that the user was judged to be too cold when seated in a 23° C. seat, that one or more seating conditions include a first condition regarding air conditioning settings, and that the first condition specifies 18° C. to 23° C. In this case, the controller 23 may determine the seat above 23° C. as the seat for the user.

For example, suppose that one or more seating conditions include a condition regarding whether or not a request for boarding/exiting assistance has been made, and that the condition is that a request for boarding/exiting assistance has been made. In this case, in the embodiment described above, the controller 23 may assist the user in boarding the bus by, for example, controlling the bus ramp, the height of the bus entrance, and/or the speed at which the doors open and close.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing method performed by an information processing apparatus configured to control operations of a bus, the information processing method comprising:
receiving from a terminal apparatus of a user a designation of one or more seating conditions desired by the user;
identifying, upon detecting a person from a video of an area around or inside the bus captured by a camera, a position of the person from the video;
determining whether the identified position of the person and a current position of the terminal apparatus match; and
determining, in a case in which they match, a seat for the user based on the one or more seating conditions.

2. The information processing method according to claim 1, further comprising notifying the user of a position of the seat.

3. The information processing method according to claim 1, wherein the information processing apparatus is configured to determine the seat for the user based on past boarding information for the user and the one or more seating conditions.

4. The information processing method according to claim 1, wherein
the one or more seating conditions include a first condition regarding an air conditioning setting,
the information processing method further comprises changing the air conditioning setting according to a number of passengers on the bus, and
the information processing apparatus is configured to determine the seat for the user based on the changed air conditioning setting and the one or more seating conditions.

5. The information processing method according to claim 1, further comprising:
detecting that the user is seated in the determined seat;
acquiring a thermographic image of the user after the user is seated; and
changing an air conditioning setting around the user based on the thermographic image of the user.

6. A method, by a processor, for improving travel mobility as a service (MaaS), comprising processing steps executed by the information processing apparatus according to claim 1.
